(19) United States
(12) Patent Application Publication
(10) Pub. No.: US 2016/0086211 A1
(43) Pub. Date: Mar. 24, 2016

(54) SYSTEM AND METHOD FOR REAL-TIME, RULES-BASED SOCIAL MEDIA AMPLIFICATION

(71) Applicant: Zaptitude, LLC, Morristown, NJ (US)

(72) Inventor: Daniel D. Lynn, Flemington, NJ (US)

(21) Appl. No.: 14/860,745

(22) Filed: Sep. 22, 2015

Related U.S. Application Data
(60) Provisional application No. 62/053,550, filed on Sep. 22, 2014.

(51) Int. Cl. G06Q 30/02; G06Q 50/00

(52) U.S. Cl. CPC G06Q 30/0214; G06Q 50/01; G06Q 30/0211

(57) ABSTRACT

The present disclosure relates to systems and methods for enabling organizations to track, monitor manage and implement customer incentives and customer referrals through social media as a means to acquire and develop new customer acquisition channels at a reasonable cost per acquisition.

### CROSS REFERENCE

The present application claims the benefit of U.S. Provisional Application No. 62/053,550 filed Sep. 22, 2014; which is herein incorporated by reference in its entirety.

### FIELD

The system and methods of the present disclosure relate to a cloud-based, real-time, rules-based incentive optimization engine to maximize sales results through media channels. This engine may be a standalone module or a component of a larger platform such as the Good Influence™ platform from Zaptitude (a.k.a. Spreddz) which tracks a user's impact on downstream users within a social media sphere.

Mores specifically, the system and method enables organizations to use customer referrals through social media as a new customer acquisition channel.

### BACKGROUND

Organizations of all sizes typically need to continue to expand their customer base and acquire new customers. Existing customer referrals through word of mouth are one of the most powerful methods for any business to acquire new customers. The cost per acquisition (CPA) for a new customer acquired as a result of a referral is very low as there are often no direct marketing costs associated with this type of acquisition. So, organizations hope to receive as many of these new customers as possible. Many organizations promote this concept with their existing customers by introducing formal customer referral programs. And, for more progressive organizations, these referral programs can provide rewards to the existing customers and/or the referred customers to maximize the results of the program. However, there isn't any cost effective way to track the results by customer or any way to understand the CPA for each new customer. Also, there isn't any way to adjust the incentives offered based on the potential social influence (social currency) of a customer.

Online referrals currently work the same way. Some organizations don't promote online referrals. One reason is because it can be too difficult and expensive to track. Other organizations promote online customer referrals but don't use incentives as part of their programs because there isn't an easy way to track the results in order to fulfill the incentives. And, the most progressive organizations use incentives to maximize the new customers driven from existing customer referrals however, there isn't any way today to adjust incentives in real-time for the existing customer or for the referrals based on the real-time referral results of a specific existing customer. And, there isn't any way today to adjust the incentives based on the potential social media influence (as measured in terms of likelihood to refer and potential incremental awareness, referrals and conversions driven) of an existing customer as determined by their downstream impact (ripple effect). Their downstream impact includes their influence plus the influence of their connections, plus the influence of the connections of their connections, and so on. And, there currently isn't a way to adjust the incentives so that the organization can hit a targeted cost per acquisition target for the referrals of a specific customer.

A system and method are needed to make referrals programs easy to implement and cost effective for any organization. In addition, a system and method are needed to adjust incentives in real-time based on the results of the incentives. Accordingly, a system and method are needed to track the current and historical downstream influence of an existing customer who refers to know exactly how big or small the incentive can be in order to drive the greatest results within a targeted cost per acquisition. Also, a system and method are needed to optimize incentive-based referral programs in an integrated fashion whether the referrals and/or conversions occur offline or online.

### BRIEF SUMMARY

Accordingly, in an embodiment, a method for customizing and maximizing a customer referral program based on a social network utilizing a computer with a processor and a memory, and a communications network is disclosed. The method comprising soliciting a customer, via the computer and communications network, to endorse a product or a service via the customer's social network in exchange for an incentive, wherein the customer's social network includes a plurality of users. Monitoring the customer's social network via the computer processor and determining if any of the users took an action in response to the endorsement. Gathering data from the users and storing the gathered data in the memory and analyzing, via the computer processor, the gathered data. Quantifying and predicting the customer's impact on the users in the social network environment and altering or maintaining the incentive to the customer based on the qualifying and predicting. Offering a second incentive to the users based on the predicting and monitoring the customer's and user's social networks to determine if the incentive has an impact on the user's and adjusting the incentives in real-time based on the monitoring.

In another embodiment the adjusting is based on a pre determined incentive program. In another embodiment the first incentive and the second incentive are the same. In still another embodiment the adjusting is dynamic and is based on an influence factor of the customer's plurality of social network contacts.

In another embodiment the adjusting is based on data provided by an organization using the system. In still another embodiment, the adjusting is based on data provided by an external provider and wherein the data is data about the customer or a customer profile.

In another embodiment third-party analytics data is used to predict which incentives have the greatest probability of success for a particular customer during a first interaction with the customer. In another embodiment the analyzing includes determining a ripple effect for the customer. In another embodiment analyzing includes a determination of the optimum incentive or mix of incentives for a particular category.

### BRIEF DESCRIPTION OF THE DRAWINGS

FIG. 1 depicts a campaign management module screen in an embodiment of the present disclosure.

FIG. 2 depicts a campaign creation screen from the campaign management module in an embodiment of the present disclosure.

FIG. 3 depicts an incentive management module screen in an embodiment of the present disclosure.

FIG. 4 depicts an automated incentive distribution and expiration screen for use with the incentive management module in an embodiment of the present disclosure.

FIG. 5 depicts an example of a report screen showing the ripple effect of a customer with a single ripple in an embodiment of the present disclosure.

FIG. 6 depicts an example of a report screen showing the ripple effect of a customer with multiple ripples in an embodiment of the present disclosure.

FIG. 7 depicts a report generated by a reporting module showing the impact of various incentives across a set of variables within a campaign in an embodiment of the present disclosure.

FIG. 8 shows a schematic view of an example embodiment of a computer network model according to the present disclosure.

FIG. 9 shows a schematic view of an example embodiment of a computer network architecture according to the present disclosure.

FIG. 10 shows a schematic view of an example embodiment of a computer network diagram according to the present disclosure.

### DETAILED DESCRIPTION

The present disclosure is now described more fully with reference to the accompanying drawings, in which example embodiments of the present disclosure are shown. The present disclosure may, however, be embodied in many different forms and should not be construed as necessarily being limited to the example embodiments disclosed herein. Rather, these example embodiments are provided so that the present disclosure is thorough and complete, and fully conveys the concepts of the present disclosure to those skilled in the relevant art.

Features described with respect to certain example embodiments may be combined and sub-combined in and/or with various other example embodiments. Also, different aspects and/or elements of example embodiments, as disclosed herein, may be combined and sub-combined in a similar manner as well. Further, some example embodiments, whether individually and/or collectively, may be components of a larger system, wherein other procedures may take precedence over and/or otherwise modify their application. Additionally, a number of steps may be required before, after, and/or concurrently with example embodiments, as disclosed herein. Note that any and/or all methods and/or processes, at least as disclosed herein, can be at least partially performed via at least one entity in any manner.

The terminology used herein can imply direct or indirect, full or partial, temporary or permanent, action or inaction. For example, when an element is referred to as being “on,” “connected” or “coupled” to another element, then the element can be directly on, connected or coupled to the other element and/or intervening elements can be present, including indirect and/or direct variants. In contrast, when an element is referred to as being “directly connected” or “directly coupled” to another element, there are no intervening elements present.

Although the terms first, second, etc. can be used herein to describe various elements, components, regions, layers and/or sections, these elements, components, regions, layers and/or sections should not necessarily be limited by such terms. These terms are used to distinguish one element, component, region, layer or section from another element, component, region, layer or section. Thus, a first element, component, region, layer, or section discussed below could be termed a second element, component, region, layer, or section without departing from the teachings of the present disclosure.

The terminology used herein is for describing particular example embodiments and is not intended to be necessarily limiting of the present disclosure. As used herein, the singular forms “a,” “an” and “the” are intended to include the plural forms as well, unless the context clearly indicates otherwise. The terms “comprises,” “includes” and/or “comprising,” “including” when used in this specification, specify the presence of stated features, integers, steps, operations, elements, and/or components, but do not preclude the presence and/or addition of one or more other features, integers, steps, operations, elements, components, and/or groups thereof.

Example embodiments of the present disclosure are described herein with reference to illustrations of idealized embodiments (and intermediate structures) of the present disclosure. As such, variations from the shapes of the illustrations as a result, for example, of manufacturing techniques and/or tolerances, are to be expected.

Unless otherwise defined, all terms (including technical and scientific terms) used herein have the same meaning as commonly understood by one of ordinary skill in the art to which this disclosure belongs. The terms, such as those defined in commonly used dictionaries, should be interpreted as having a meaning that is consistent with their meaning in the context of the relevant art and should not be interpreted in an idealized and/or overly formal sense unless expressly so defined herein.

Furthermore, relative terms such as “below,” “lower,” “above,” and “upper” can be used herein to describe one element's relationship to another element as illustrated in the accompanying drawings. Such relative terms are intended to encompass different orientations of illustrated technologies in addition to the orientation depicted in the accompanying drawings. For example, if a device in the accompanying drawings were turned over, then the elements described as being on the “lower” side of other elements would then be oriented on “upper” sides of the other elements. Similarly, if the device in one of the figures were turned over, elements described as “below” or “beneath” other elements would then be oriented “above” the other elements. Therefore, the example terms “below” and “lower” can encompass both an orientation of above and below.

If any disclosures are incorporated herein by reference and such disclosures conflict in part and/or in whole with the present disclosure, then to the extent of conflict, and/or broader disclosure, and/or broader definition of terms, the present disclosure controls. If such disclosures conflict in part and/or in whole with one another, then to the extent of conflict, the later-dated disclosure controls.

In an embodiment, the system and method, allows organizations to drive incremental brand awareness, brand engagement, and sales (or other types of conversions) by leveraging the referrals of their existing customers on social media. An embodiment of the present system and method may enable an organization to maximize these results by incentivizing existing customers at any point of conversion to share via their social media connections and then incentivizing those downstream connections of the customers to make a purchase.

In an embodiment, the system and method of the present disclosure allow, real-time, optimization (using, e.g., A/B testing, multivariate testing, automated rules, predictive modeling, and any other optimization techniques) of the incentives to maximize the results within a predefined cost per acquisition (CPA) target.

In an embodiment, incentives can also be optimized in real-time based on one or a combination of the following: data from a influence systems such as the Good Influence system; data provided by the organization using the system; or external partner data about the customer or the customer's segment or profile. In this manner, in an embodiment, by using outside analytics data and/or data gathered from the system on which incentives provided the greatest results, the system can predict which incentives would have the greatest probability of success most for a particular customer during the first interaction with that customer.

In an embodiment, utilizing a platform that tracks downstream activity within a social media sphere, like Zaptitude's Good Influence platform, an organization is able to capture the ripple effect of every customer share (aka referral) and what is driving that share. In other words, an organization through a platform such as Good influence can track the downstream impact of any customer share in terms of awareness generated, referrals driven, and incremental sales created. In this way, an organization can know the incremental cost associated with obtaining a new customer. It may track this for the connections of the sharer as well as for the connections of those connections and the connections of the connection's connections, and so on and so on.

In an embodiment, utilizing and tracking this ripple data, the systems and method of the present disclosure is able to use the ripple effect data to monitor and provide all downstream referrals from any customer an incentive similar or identical to the same incentive as that customer, if desired by the organization. This allows organizations to manage multiple offers and incentives but also ensures that the same offer or incentive can be used for all interactions within a single stream of ripples. It allows the organization to dynamically adjust the incentive mix at any point in the campaign based on the downstream impact of any customer. It also may enable an organization to understand 1) which customers are most likely to share and 2) which customers have the highest impact from sharing in terms of: awareness (Impressions), engagement, conversions, number of downstream actions driven within their own immediate network (once removed), the number of downstream actions driven beyond their own immediate network (beyond once removed), the number of ripples generated (their connections, the connections of their connections, the connections of their connection's connections, and so on) and the volume within any ripple as it compares to other ripples, and finally, which customers have the most influential social media networks.

In an embodiment, incentives may be adjusted based on the unique data in near real time. For example, a customer that is more influential may receive a better incentive than a less influential customer because their potential based on historical downstream impact or profiling may enable the organization to hit a target Cost Per Acquisition (“CPA”) metric.

In an embodiment, the system and method may be implemented utilizing four modules within an amplify incentive optimization engine in accordance with the present disclosure. It will be appreciated by those skilled in the art, that other configurations and other modules are possible. In an embodiment, there could be more or fewer modules, and they may be implemented based on the number of customers, ripples, or incentives offered. In another embodiment, the main modules may be a campaign management module, an incentive management module, an incentive rules optimization engine module and a reporting module. As will be understood by those skilled in the art, the modules can be further combined or additional modules can be utilized in a coordinated system. As will be further appreciated by those skilled in the art, the systems and method may be implemented on a single computer utilizing a single processor or on any number of computers or processors. The system may be implemented on a local network, a wide area network or the internet. Communications and connectivity may be wired or wireless. Data may be stored locally or remotely and may be stored in a cloud based network. The systems and method of the present disclosure may be offered as software or may be offered as a service.

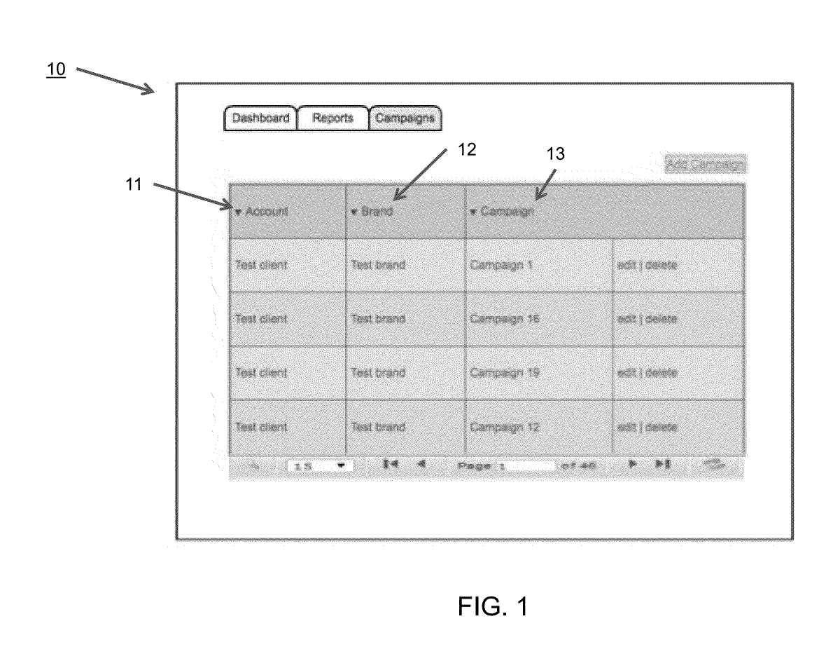

FIG. 1 depicts a display of a campaign management module 10 in accordance with an embodiment of the present disclosure. Account 11 is an organization that has agreed to use the system. These accounts are created and maintained within the overall system platform in a database. The database may be flat, relational or arranged in any other manner. Brand 12, is a brand subaccount within an Account 11. It is a way for the system platform to have a hierarchy within an individual Account 11. Each Account 11 must have at least one Campaign 13 in order for the system platform to engage a customer, motivate them to share, and track results for an account. For example, the Account might be Ford Motor Company, and the brand may be Mustang.

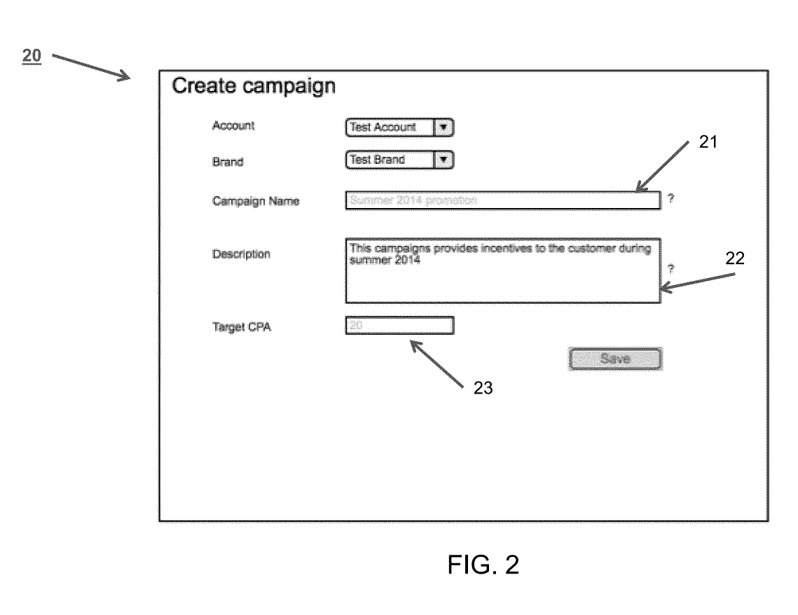

FIG. 2 is a mock up of a screen campaign module 20 in accordance with an embodiment of the present disclosure. Campaign module 20 allows a contact within an organization or an account manager within an agency or organization to create (add), edit, or delete a campaign for any account within the software engine.

Data used for creating a campaign may include the date created (not shown) which may be a time stamp from the system as to when a campaign is created. Campaign Number also not shown in FIG. 2 may be a unique system generated ID used for campaign identification. Campaign Name 21 may be designated by the organization and may be used to help the organization identify the campaign. Campaign Description 22 is used to help the organization have a more detailed summary of the campaign and target CPA 23 may be entered by the organization as the target average cost it is willing to pay to acquire a new customer. The systems and methods of the present disclosure then, in real-time, optimize the incentive mix to maximize the results within this target CPA.

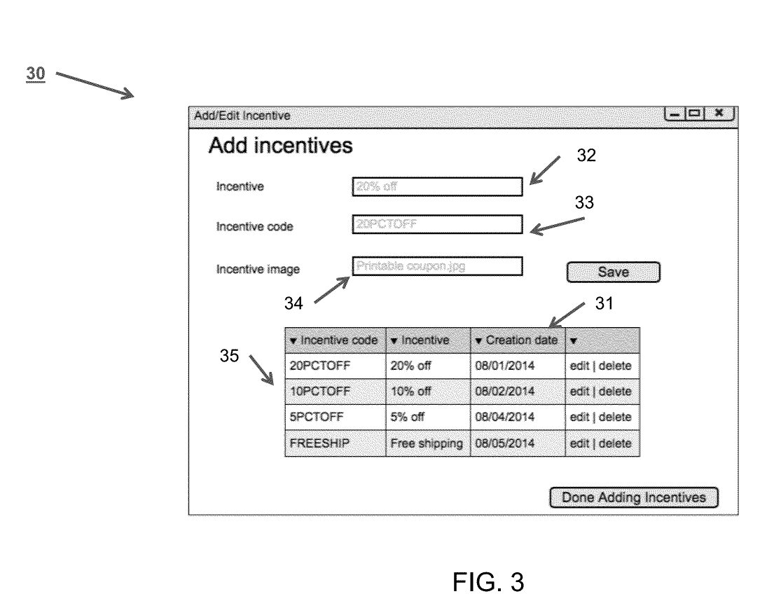

FIG. 3 depicts an incentive management module 30. Incentive module 30 allows the organization to add, edit, or delete an incentive that is associated with different campaigns within the software engine. Creation Date 31 is automatically added through a time stamp from the system indicating when the campaign was created. Incentive 32 is the title given by the organization for the particular incentive. Incentive Code 33 is a code a customer will use for an incentive. This is created and assigned by the organization. This typically correlates to a promotion code or discount code within the organization's ecommerce platform. Incentive Image 34 may allow an organization to associate an image with an incentive. Summary screen 35 allows an organization to see all the incentives for a specific campaign in a tabular format. In an embodiment, an organization can develop its own incentives to use or it can select from a variety of incentives offered in the system.

In an embodiment, the system may comprise a “personal results page”. The personal results page may allow a user to see their personal activity related to referrals including how many times they shared, how many referrals they provided, and how many of those referrals became customers of the organization. The user can also see, based on their activity, how many of the incentives they've qualified for.

In an embodiment, the personal results page would provide a user with access to an online community that shows the user's personal statistics in relation to other customers. For large established brands, the community could be segmented based on region, product purchased, demographic, etc. By participating in the online community, in an embodiment, users could select from a variety of incentives for attaining certain benchmarks. These communities can provide organizations with data on which incentives are best for different types of users. The data would then be utilized by the incentive optimization system.

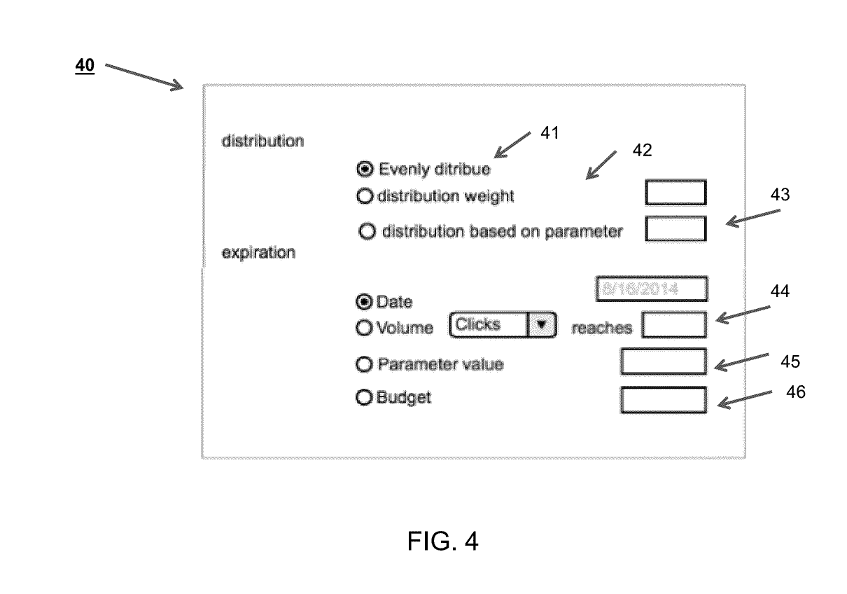

FIG. 4 depicts automated incentive distribution and expiration screen 40 in accordance with and embodiment of the present disclosure. In an embodiment, an organization can “tell” the system several different methods for distributing incentives to Sharers (e.g., customers who share on social media) and Referrals (connections who are driven to the organization as a result of a share from a customer). Automated incentive distribution and expiration screen 40 may have selectors such as evenly distribute 41 which will distribute incentives equally; apply distribution weights 42, which will distribute incentives based on a weight assigned by the organization, or a distribution based on a passed indicator 43. Distribution based on a passed indicator 43 is a parameter or other indicator that may be passed by the organization to the amplify system through JavaScript or other method to identify which incentive rule the amplify system should use for a particular customer. This allows the organization to have complete control over which incentives are used for every customer.

In an embodiment, the organizations can also use several methods to determine when an incentive will expire including: by date 44, volume 45, Parameter Value, 46 or Budget 47. Volume 44 may be set to have the selected incentive program expire based on a certain volume of views, clicks or conversions. Parameter value 46 may set a campaign to expire or pause based on a parameter passed by the organization within the JavaScript or other method and budget 47 may be used to set the incentive to expire when a budget is reached. For example, an organization may assign a cost to each incentive. Then, it can select a budget for the incentive and have the promotion expire as soon as the budget is reached. In an embodiment, the “rules” for distribution and expiration can be assigned separately for both the sharer and the referral.

In an embodiment, module 3 may be an incentive rules optimization engine module. Using various optimization technics and algorithms, in an embodiment, the rules engine module, automates the optimization of each campaign in real-time. This may be done by determining the incentive mix that delivers the maximum results (in terms of brand awareness, brand engagement, and conversions—as determined by the organization) at the lowest cost. The uniqueness of the data allows the system to use scoring methodology and algorithms to create significantly more value for organizations and drive substantially more revenue through new customer acquisition and conversion. These algorithms may include but are not limited to a customer's influence scoring algorithm. While the algorithms may incorporate unique data from the system, in an embodiment, they also include data provided by the organization using the system and/or external partner data about the customer the customer's segment or profile.

Based on of the system's ability to capture a customer's influence and their downstream ripple effect, a unique customer scoring algorithm may be used based on data that includes a customer's likelihood of sharing, i.e., how likely is a customer willing to share on social media, what channels are they willing to share on, what types of information are they willing to share (promotions, contests, news, updates, etc.), what message formats are they willing to share (text, video, images, links, etc.), how often are they willing to share, which types of messages drive them to share, which incentives drive them to share, which customer actions or interactions create the best opportunity for asking them to share, and when is the best time to ask them to share. All this data is available and collectable over time and from the system that tracks and gathers information related to a user's downstream ripple effect. Furthermore, an additional basis for scoring a customer is the customer influence level. Specifically, in an embodiment, the system may use data such as the influence of a customer's immediate connections (Ripple 1), i.e., how many referrals and how many conversions is a customer able to drive from their direct connections on social media.

Similarly, the influence of a customer's overall network (i.e., the second generation of Ripples 2+). For example, how many referrals and how many conversions is a customer able to drive through their networks as a result of their influence and a result of the influence of the connections within their social media networks.

Additionally, the influence of a customer's overall network (Ripples 1+) can be used because the system captures the data in real-time and historically as to how many referrals and how many conversions is a customer able to drive through their entire network as a result of the influence of the connections within their social media networks is available to the present system.

A customer's lift is also a quantifiable value that may be used to drive and determine incentives. Customer lift is the number of new transactions a customer is able to drive based on his or her influence, i.e., how much new revenue a customer is able to drive based on his or her influence. Other factors such as the percentage of increase a customer is able to generate in terms of transactions relative to his or her own transactions is a measurable value that can be captured by the system. Similarly, the system can track and use the percentage of increase a customer is able to generate in terms of revenue relative to his or her own revenue. All these values may be used to determine what incentives and what promotions/rewards should be offered to a particular customer for a given campaign. This data may be captured based on the customer's influence via social networking channels.

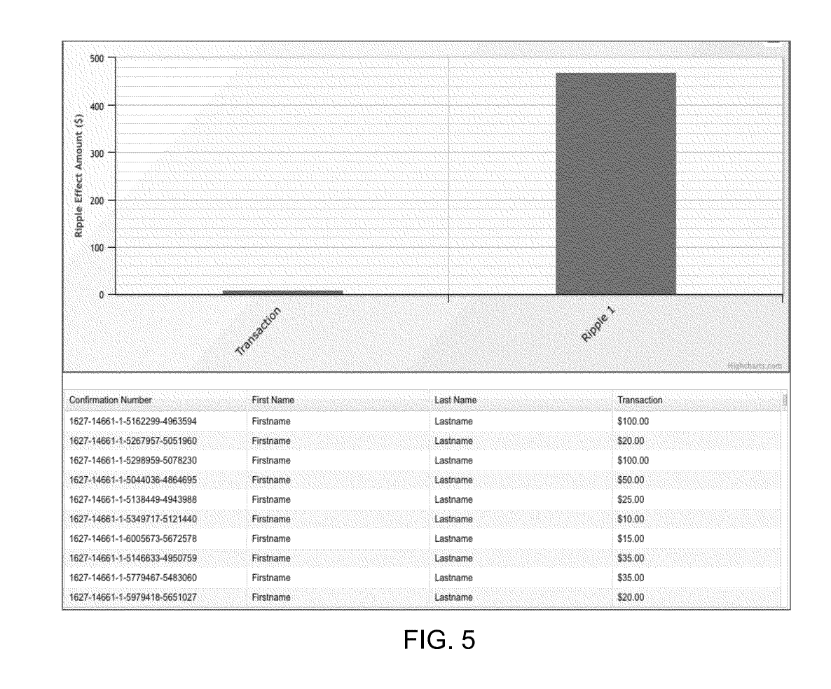

FIG. 5 depicts a sample showing a small original customer transaction with significant influence in the first ripple. As will be understood, while the customer made a small purchase, they had significant influence, which drove 10 new transactions from their immediate connections. However, their connections did not have a similar type of influence. In this example a second ripple was not generated which means that none of the original customer's connections drove any incremental transactions.

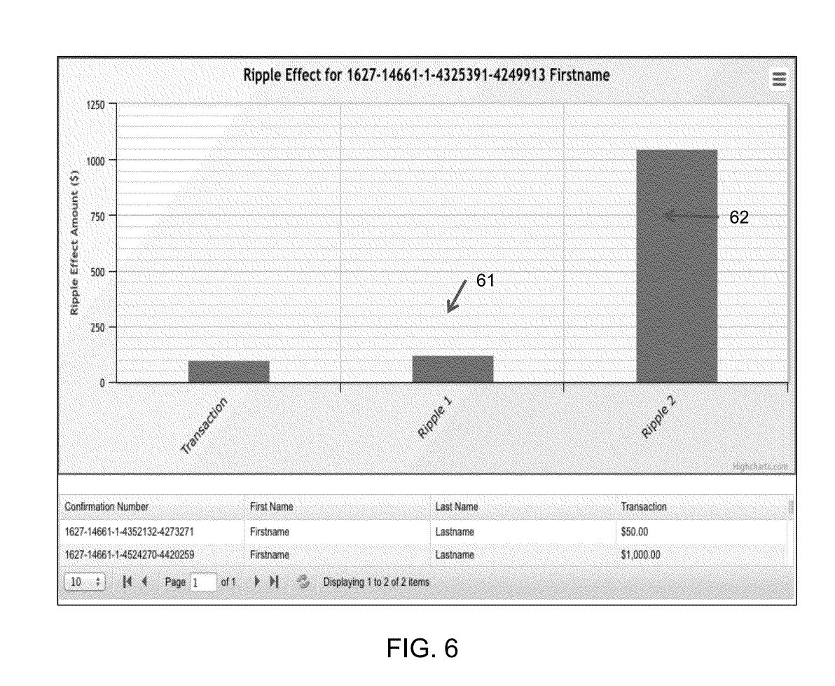

FIG. 6 depicts an example showing the impacts of a customer's subsequent ripples. The original transaction was small in nature, but the customer shared the experience with his or her social network. Although the original customer (Customer 1) had little influence with their immediate connections (Ripple 1) 61, one of the connections purchased (Customer 2) and shared with their connections (Ripple 2) 62. Customer 2 was more influential than Customer 1 driving two additional transactions where one was of substantially more value.

Utilizing such information, incentives may be ranked and selected to maximize an organization's expenditures of resources and incentives to obtain new customers and ensure return on cost of acquiring new customers. For example, the present system and method can change incentives in real-time based on the customer scores developed by the system.

Because the system of the present disclosure is able to track the ripple effect impact for any customer, or work as part of a system that does, it may assign an influence score. Because it can assign an influence score, it can dynamically and autonomously adjust incentives based on that score. For example, in an embodiment, it may give a customer with a higher influence score a more substantial incentive to share. While this incentive for a customer with a lower score could exceed the CPA target, it may not exceed that target for a more influential customer with a greater potential impact. In such a manner, an organization can optimize incentives based on the potential impact of a specific customer. Additionally, in an embodiment, the system can adjust future incentives for that customer based on that customer's real-time score, which is based on their history of results through the system.

Additionally and or alternatively, based on customer scoring and other appended data the real-time offering of incentives based on the customer scores developed by the system in combination with customer demographic, psychographic, purchase behavior, and other data provided by the organization can be utilized. In an embodiment, the system may generate real-time electronic reports showing the results for each incentive within each campaign. Additionally, and/or alternatively, if the organization wants, the optimization engine of the present system can automate optimization of each campaign in real-time, thereby determining and implementing the incentive mix that delivers the maximum results in terms of brand awareness, brand engagement, and conversions at the lowest cost per acquisition.

In an embodiment, cost per acquisition (CPA) may be calculated based on the volume of shares, which is multiplied by the cost for the incentive for each share. It may be computed based on referrals. For example, in an embodiment, the volume of conversions is multiplied by the cost for the incentive for each referral that converts. The system knows whether a referral converts or not based on a tracking pixel installed on an organization's website or passed by the organization using another method. Accordingly, if there is an offline conversion, the organization will pass a code into the optimization engine.

CPA can also be automatically calculated in real-time for each incentive based on A+B/Conversions. Additionally, and/or alternatively, a 30, 60 or 90-day cookie for all conversions can be used so that any referral that clicks through to the redirect URL but doesn't convert initially and then returns and converts within the 30-90 day period will count as a conversion for that incentive and, as a result, be factored into the system metrics and calculations.

In an embodiment, a reporting module may be used. The reporting module may provide an organization with real-time results for each campaign and each incentive within a campaign. It may allow an organization to export data into various file formats or, if the organization wants to integrate the data into other enterprise systems, it can take advantage of a reporting API. In an embodiment, the system can also use data from enterprise systems in real time in order to augment prior data gathered by the incentive optimization system and the consumer influence scores that it has generated.

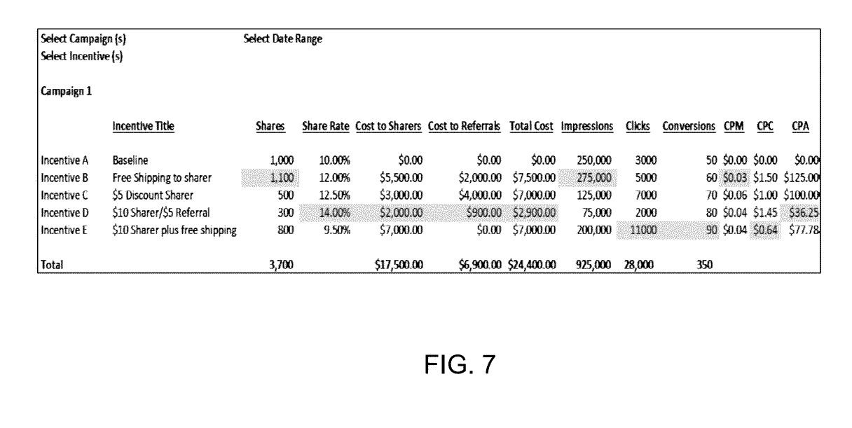

FIG. 7 depicts the ‘winning’ incentive or mix of incentives for a particular category. As an example, Incentive B indicates the best performing incentive in terms of Shares, Impressions, and CPM. However, Incentive D indicates the best performing incentive in terms of Share Rate, Cost to Sharers, Cost to Referrals, Total Cost, and CPA. Based on such report information, an organization may chose which metrics are most important to it. Based on such selection, the system automatically or under the organization's control may optimize the campaign for those particular metrics.

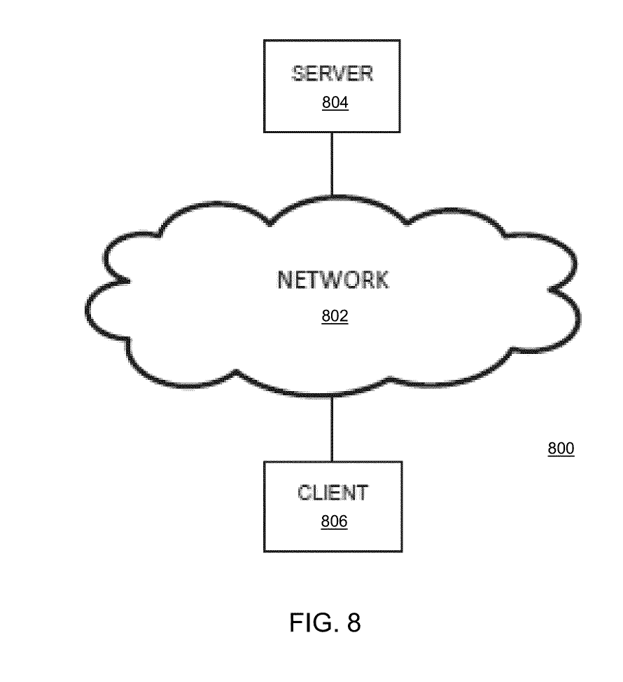

FIG. 8 shows a schematic view of an example embodiment of a computer network model according to the present disclosure. A computer network model 80 comprises a network 82, a server 84, and a client 86. Such distributed operation model allocates tasks/workloads between the server 84, which provides a resource/service, and the client 86, which requests the resource/service. The server 84 and the client 86 illustrate different computers/applications, but in other embodiments, the server 84 and the client 86 reside in one system/application. Further, in some embodiments, the model 80 entails allocating a large number of resources to a small number of computers, such as the servers 84, where complexity of the client 86 depends on how much computation is offloaded to the number of computers, i.e., more computation offloaded from the clients 86 onto the servers 84 leads to lighter clients 86, such as being more reliant on network sources and less reliant on local computing resources.

The network 82 includes a plurality of nodes, such as a collection of computers and/or other hardware interconnected via a plurality of communication channels, which allow for sharing of resources and/or information. Such interconnection can be direct and/or indirect. The network 82 can be wired and/or wireless. The network 82 can allow for communication over short and/or long distances, whether encrypted and/or unencrypted. The network 82 can operate via at least one network protocol, such as Ethernet, a Transmission Control Protocol (TCP)/Internet Protocol (IP), and so forth. The network 82 can have any scale, such as a personal area network, a local area network, a home area network, a storage area network, a campus area network, a backbone network, a metropolitan area network, a wide area network, an enterprise private network, a virtual private network, a virtual network, a satellite network, a computer cloud network, an internetwork, a cellular network, and so forth. The network 82 can be and/or include an intranet and/or an extranet. The network 82 can be and/or include Internet. The network 82 can include other networks and/or allow for communication with other networks, whether sub-networks and/or distinct networks, whether identical and/or different from the network 82. The network 82 can include hardware, such as a computer, a network interface card, a repeater, a hub, a bridge, a switch, an extender, and/or a firewall, whether hardware based and/or software based. The network 82 can be operated, directly and/or indirectly, by and/or on behalf of one and/or more entities, irrespective of any relation to contents of the present disclosure.

The server 84 can be hardware-based and/or software-based. The server 84 is and/or is hosted on, whether directly and/or indirectly, a server computer, whether stationary or mobile, such as a kiosk, a workstation, a vehicle, whether land, marine, or aerial, a desktop, a laptop, a tablet, a mobile phone, a mainframe, a supercomputer, a server farm, and so forth. The server computer can be touchscreen enabled and/or non-touchscreen. The server computer can include and/or be a part of another computer system and/or a cloud computing network. The server computer can run any type of operating system (OS), such as iOS®, Windows®, Android®, Unix®, Linux®. and/or others. The server computer can include and/or be coupled to, whether directly and/or indirectly, an input device, such as a mouse, a keyboard, a camera, whether forward-facing and/or back-facing, an accelerometer, a touchscreen, a biometric reader, a clicker, and/or a microphone. The server computer can include and/or be coupled to, whether directly and/or indirectly, an output device, such as a display, a speaker, a headphone, a joystick, a videogame controller, a vibrator, and/or a printer. In some embodiments, the input device and the output device can be embodied in one unit. The server computer can include circuitry for global positioning determination, such as via a global positioning system (GPS), a signal triangulation system, and so forth. The server computer can be equipped with near-field-communication (NFC) circuitry. The server computer can host, run, and/or be coupled to, whether directly and/or indirectly, a database, such as a relational database or a non-relational database, which can feed data to the server 84, whether directly and/or indirectly.

The server 84, via the server computer, is in communication with the network 82, such as directly and/or indirectly, selectively and/or unselectively, encrypted and/or unencrypted, wired and/or wireless, via contact and/or contactless. Such communication can be via a software application, a software module, a mobile app, a browser, a browser extension, an OS, and/or any combination thereof. For example, such communication can be via a common framework/application programming interface (API), such as Hypertext Transfer Protocol Secure (HTTPS).

The client 86 can be hardware-based and/or software-based. The client 86 is and/or is hosted on, whether directly and/or indirectly, a computer, whether stationary or mobile, such as a terminal, a kiosk, a workstation, a smart device, a mobile device, a vehicle, whether land, marine, or aerial, a desktop, a laptop, a tablet, a mobile phone, a mainframe, a supercomputer, a server farm, and so forth. The computer can be touchscreen enabled and/or non-touchscreen. The computer can include and/or be a part of another computer system and/or cloud computing network. The computer can run any type of OS, such as iOS®, Windows®, Android®, Unix®, Linux® and/or others. The computer can include and/or be coupled to an input device, such as a mouse, a keyboard, a camera, whether forward-facing and/or back-facing, an accelerometer, a touchscreen, a biometric reader, a clicker, and/or a microphone, and/or an output device, such as a display, a speaker, a headphone, a joystick, a videogame controller, a vibrator, and/or a printer. In some embodiments, the input device and the output device can be embodied in one unit. The computer can include circuitry for global positioning determination, such as via a GPS, a signal triangulation system, and so forth. The computer can be equipped with NFC circuitry. The computer can host, run and/or be coupled to, whether directly and/or indirectly, a database, such as a relational database or a non-relational database, which can feed data to the client 86, whether directly and/or indirectly.

The client 86, via the computer, is in communication with network 82, such as directly and/or indirectly, selectively and/or unselectively, encrypted and/or unencrypted, wired and/or wireless, via contact and/or contactless. Such communication can be via a software application, a software module, a mobile app, a browser, a browser extension, an OS, and/or any combination thereof. For example, such communication can be via a common framework/API, such as HTTPS.

In other embodiments, the server 84 and the client 86 can also directly communicate with each other, such as when hosted in one system or when in local proximity to each other, such as via a short range wireless communication protocol, such as infrared or Bluetooth®. Such direct communication can be selective and/or unselective, encrypted and/or unencrypted, wired and/or wireless, via contact and/or contactless. Since many of the clients 86 can initiate sessions with the server 84 relatively simultaneously, in some embodiments, the server 84 employs load-balancing technologies and/or failover technologies for operational efficiency, continuity, and/or redundancy.

Note that other computing models are possible as well. For example, such models can comprise decentralized computing, such as peer-to-peer (P2P), for instance Bit-Torrent®, or distributed computing, such as via a computer cluster where a set of networked computers works together such that the computer can be viewed as a single system.

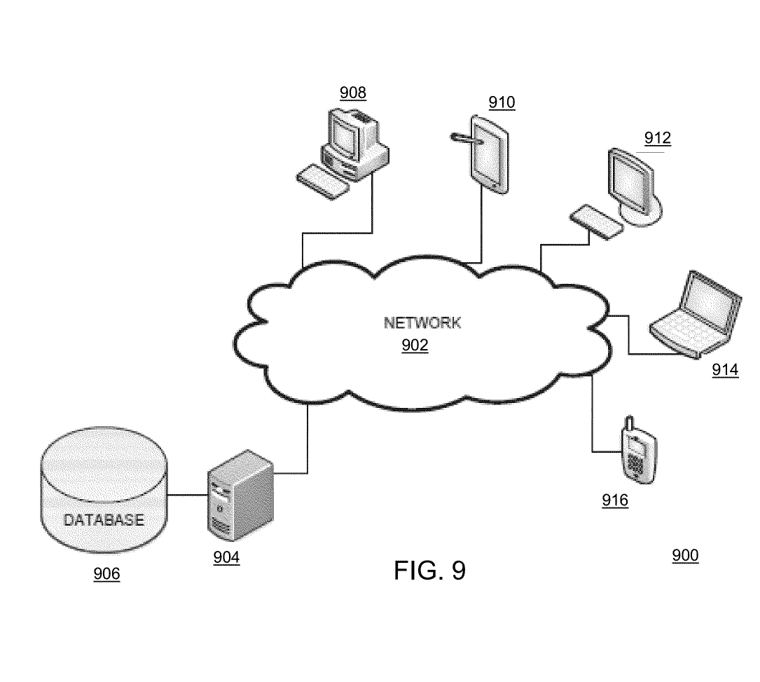

FIG. 9 shows a schematic view of an example embodiment of a computer network architecture according to the present disclosure. A computer network architecture 900 comprises a network 902 in communication with a service provider segment and with a service requester segment. The service provider segment comprises a server computer 904 and a database 906. The service requester segment comprises a workstation computer 908, a tablet computer 910, a desktop computer 912, a laptop computer 914, and mobile phones 916. The architecture 900 operates according to the model 800. However, in other embodiments, the architecture 900 operates according to other computing models, as described herein, such as direct communication, decentralized computing, distributed computing, and/or any combinations thereof. The network 902 operates according to the network 802. However, in other embodiments, the network 902 operates according to other network types, as described herein.

Note that the service provider segment can comprise more than one server computer 904 and/or more than one database 906, whether structurally and/or functionally identical and/or different from each other, whether communicatively coupled to each other and/or not communicatively coupled to each other, such as directly and/or indirectly, wired and/or wireless, selectively and/or unselectively, encrypted and/or unencrypted, via contact and/or contactless, whether synchronous and/or asynchronous, whether controlled via a single entity and/or via a plurality of entities, irrespective of any relation to contents of the present disclosure. Likewise, note that the service requester segment can comprise less than five and/or more than five computers 908, 910, 912, 914, 916 whether structurally and/or functionally identical and/or different from each other, whether communicatively coupled to each other and/or not communicatively coupled to each other, such as directly and/or indirectly, wired and/or wireless, selectively and/or unselectively, encrypted and/or unencrypted, via contact and/or contactless, whether synchronous and/or asynchronous, whether controlled via a single entity and/or via a plurality of entities, irrespective of any relation to contents of the present disclosure.

The computer 904 is in communication with the network 902, such as directly and/or indirectly, wired and/or wireless, selectively and/or unselectively, encrypted and/or unencrypted, via contact and/or contactless, whether synchronous and/or asynchronous. The computer 904 facilitates such communication via a hardware unit, such as a hardware component of the computer 904, for example, a network card. However, in other embodiments, the computer 904 facilitates such communication via a software unit, such as a software application, a software module, a mobile app, a browser, a browser extension, an OS, and/or any combination thereof. For example, such communication can be via a common framework/API, such as HTTPS. Due to a size of the service requester segment, the computer 904 employs load-balancing technologies and/or failover technologies for operational efficiency, continuity, and/or redundancy.

The computer 904 is operably coupled to the database 906 such that the computer 904 is in communication with the database 906, such as directly and/or indirectly, wired and/or wireless, selectively and/or unselectively, encrypted and/or unencrypted. The computer 904 facilitates such communication via a hardware unit, as a hardware component of the computer 904, for example, a network card. However, in other embodiments, the computer 904 facilitates such communication via a software unit, such as a software application, a software module, a mobile app, a browser, a browser extension, an OS, and/or any combination thereof. For example, such communication can be via a common framework/API, such as HTTPS, employed via a database management system (DBMS) hosted on the computer 904, such as MySQL®, Oracle®, or other suitable systems. Also, note that the computer 904 can host the database 906 locally and/or access the database 906 remotely. Alternatively, the computer 904 and the database 906 can be in one locale, yet distinctly embodied. Further, note that the computer 904 can host and/or be operably coupled to more than one database 906, such as directly and/or indirectly, wired and/or wireless, selectively and/or unselectively, encrypted and/or unencrypted, via contact and/or contactless, whether synchronous and/or asynchronous. Also, note that the database 906 can be hosted on more than one computer 904, such as directly and/or indirectly, wired and/or wireless, selectively and/or unselectively, encrypted and/or unencrypted, via contact and/or contactless, whether synchronous and/or asynchronous.

The database 906 comprises an organized collection of data. The data can be of any type, whether a primitive type, such as a Boolean and/or a character, a composite type, such as an array and/or a union, and/or an abstract data type, such as a list, a queue, a deck, a stack, a string, a tree, and/or a graph. The data can be organized of any structure, such as a linear structure, such as an array, a map, a table, a matrix, a vector, and/or a list, a tree structure, such as a tree, a pagoda, a treap, a heap, and/or a trie, a hash structure, such as a table, a list, and/or a filter, a graph structure, such as a graph, a matrix, a stack, and/or a diagram, and/or any combinations of any thereof. The organized collection of data can contain content, such as information, language-related disorder shell information, language-related disorder cell information, matrix information, master matrix information, analytics information, and/or other relevant information. The database 906 is accessed via the computer 904, such as via the DBMS running on the computer 906. The database 906 is a relational database, but other database models are possible, such as post-relational. Note that although the computer 904 and the database 906 are distinctly positioned from each other, in other embodiments, the computer 904 hosts the database 906. Note that the computer 904 and the database 906 are operated via a single actor, but in other embodiments, the computer 904 and the database 906 are operated via different actors. Further, note that the database 906 can be in communication with the network 902 such that the computer 904 communicates with the database 906 via the network 902.

The workstation computer 908, the tablet computer 910, the desktop computer 912, the laptop computer 914, and the mobile phones 916 are in communication with the network 902, such as directly and/or indirectly, wired and/or wireless, selectively and/or unselectively, encrypted and/or unencrypted, synchronous and/or asynchronous, on-demand and/or non-on-demand. In any combinatory manner, the workstation computer 908, the tablet computer 910, the desktop computer 912, the laptop computer 914, and the mobile phones 916 facilitate such communication via a hardware unit, such as a hardware component of the workstation computer 908, the tablet 910, the desktop computer 912, the laptop computer 914, and the mobile phone 916, for example, a transceiver and/or a network card. In other embodiments, the workstation computer 908, the tablet computer 910, the desktop computer 912, the laptop computer 914, and the mobile phones 916 facilitate such communication via a software unit, such as a software application, a software module, a mobile app, a browser, a browser extension, an OS, and/or any combination thereof. For example, such communication can be via a common framework/API, such as HTTPS. Further, note that other types of service requesters are possible, such as a standalone camera, an automated teller machine (ATM), a crypto-currency miner, a kiosk, a terminal, a wearable computer, such as an eyewear computer, an implanted computer, or other suitable computing devices.

Note that at least two of the workstation computer 908, the tablet computer 910, the desktop computer 912, the laptop computer 914, and the mobile phones 916 can communicate via the network 902 concurrently and/or non-concurrently, in an identical manner and/or in a different matter. Further, note that the workstation computer 908, the tablet computer 910, the desktop computer 912, the laptop computer 914, and the mobile phones 916 are operated via different actors, but in other embodiments, at least two of the workstation computer 908, the tablet 910, the desktop computer 912, the laptop computer 914, and the mobile phones 916 are operated via a single actor.

The service provider segment serves data via the network 902 to the service requester segment. Such serving can be via push technology and/or pull technology. For example, the push technology enables request initiation via the service provider segment, such as via the computer 904. Resultantly, periodically updateable information can be pushed via the computer 904, such as via synchronous conferencing, messaging, and/or file distribution, onto the service requester segment. Also, for example, the pull technology enables request initiation via the service requester segment, such as via the mobile phones 916. Resultantly, information can be pulled via the mobile phones 916, such as via web browsing, and/or web feeding, from the service provider segment.

In one mode of operation, howl data is provided via the service provider segment to the service requester segment via the network 902. For example, the computer 904 feeds the howl data from the database 906 onto the mobile phones 916, on-demand. The computer 904 receives input from the mobile phones 916 and processes such responses dynamically.

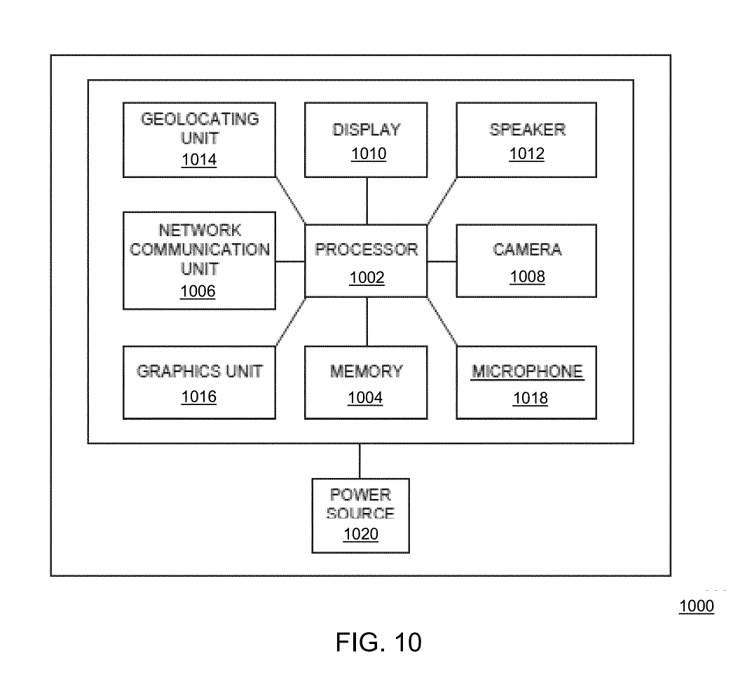

FIG. 10 shows a schematic view of an example embodiment of a computer according to the present disclosure. A computer 1000 comprises a processor 1002, a memory 1004 operably coupled to the processor 1002, a network communication unit 1006 operably coupled to the processor 1002, a camera 1008 operably coupled to the processor 1002, a display 1010 operably coupled to the processor 1002, a speaker 1012 operably coupled to the processor 1002, a geo-locating unit 1014 operably coupled to the processor 1002, a graphics unit 1016 operably coupled to the processor 1002, and a microphone 1018 operably coupled to the processor 1002. The computer 1000 comprises a power source 1020, which powers the processor 1002, the memory 1004, the network communication unit 1006, the camera 1008, the display 1010, the speaker 1012, the geo-locating unit 1014, the graphics unit 1016, and the microphone 1018. Although at least two of the processor 1002, the memory 1004, the network communication unit 1006, the camera 1008, the display 1010, the speaker 1012, the geo-locating unit 1014, the graphics unit 1016, the microphone 1018, and power source 1020 are embodied in one unit, at least one of the processor 1002, the memory 1004, the network communication unit 1006, the camera 1008, the display 1010, the speaker 1012, the geo-locating unit 1014, the graphics unit 1016, the microphone 1018, and power source 1020 can be operably coupled to the computer 1000 when standalone, such as locally or remotely, directly or indirectly. Further, in other embodiments, the computer 1000 lacks at least one of the network communication unit 1006, the camera 1008, the display 1010, the speaker 1012, the geo-locating unit 1014, the graphics unit 1016, and the microphone 1018. Note that the computer 1000 can comprise other units, whether an input unit and/or an output unit, such as a biometric reader, a clicker, a vibrator, a printer, and so forth.

The processor 1002 comprises a hardware processor, such as a multicore processor. For example, the processor 1002 comprises a central processing unit (CPU). The memory 1004 comprises a computer-readable storage medium, which can be non-transitory. The medium stores a plurality of computer-readable instructions, such as a software application, for execution via the processor 1002. The instructions instruct the processor 1002 to facilitate performance of a method for diagnosis and/or therapy of language-related disorder, as described herein. Some examples of the memory 1004 comprise a volatile memory unit, such as random access memory (RAM), or a non-volatile memory unit, such as a hard disk drive or a read only memory (ROM). For example, the memory 1004 comprises flash memory. The memory 1004 is in wired communication with the processor 1002. Also, for example, the memory 1002 stores a plurality of computer-readable instructions, such as a plurality of instruction sets, for operating at least one of the network communication unit 1006, the camera 1008, the display 1010, the speaker 1012, the geo-locating unit 1014, the graphics unit 1016, the microphone 1018, or other input and/or output units.

The network communication unit 1006 comprises a network interface controller for computer network communication, whether wired or wireless, direct or indirect. For example, the network communication unit 1006 comprises hardware for computer networking communication based on at least one standard selected from a set of Institute of Electrical and Electronics Engineers (IEEE) 802 standards, such as an IEEE 802.11 standard. For instance, the network communication unit 1006 comprises a wireless network card operative according to a IEEE 802.11(g) standard. The network communication unit 1006 is in wired communication with the processor 1002.

The camera 1008 comprises a lens for image capturing, such as a photo and/or a video. The camera 1008 stores captured visual information on the memory 1004, which can be in a compressed format or an uncompressed format. The camera 1008 can allow image display on the display 1010, such as before, during and/or after image capture. The camera 1008 can comprise a flash illumination unit. The camera 1008 can allow for zooming, whether optical or software based. The camera 1008 is in wired communication with the processor 1002. The camera 1008 can also be remotely coupled to the processor 1002, such as wirelessly.

The display 1010 comprises an area for displaying visual and/or tactile information. The display 1010 comprises at least one of an electronic visual display, a flat panel display, a liquid crystal display (LCD), and a volumetric display. For example, the display 1010 comprises a touch-enabled computer monitor. The display 1010 is in wired communication with the processor 1002. The display 1010 can also be remotely coupled to the processor 1002, such as wirelessly.

The speaker 1012 comprises a loudspeaker, such as an electroacoustic transducer providing sound responsive to an electrical audio signal input. For example, the speaker 1012 is a dynamic speaker. The speaker 1012 is in wired communication with the processor 1002. The speaker 1012 can also be remotely coupled to the processor 1002, such as wirelessly.

The geo-locating unit 1014 comprises a GPS receiver. The geo-locating unit 1014 is in communication with the processor 1002. Note that other types of geo-location are possible, such as via cell site signal triangulation. The geo-locating unit 1014 can also be remotely coupled to the processor 1002, such as wirelessly.

The graphics unit 1016 comprises a graphics processing unit (GPU) for image processing. The graphics unit 1016 is a graphics dedicated unit, but in other embodiments, the processor 1002 is integrated with the graphics unit 1016. For example, the graphics unit 1016 comprises a video card. The graphics unit 1016 is in wired communication with the processing unit 1002.

The microphone 1018 comprises an acoustic-to-electric transducer/sensor operative to convert sound in air into an electrical signal for subsequent use, such as output via the speaker 1012. The microphone 1018 can be electromagnetic induction based, capacitance change based, or piezoelectric based. The microphone 1018 can be coupled to a preamplifier upstream from an audio power amplifier. For example, the microphone 1018 is a dynamic microphone. The microphone 1018 can also be remotely coupled to the processor 1002, such as wirelessly.

The power source 1020 powers the computer 1000. The power source 1020 comprises at least one of an onboard rechargeable battery, such as a lithium-ion battery, and an onboard renewable energy source, such as a photovoltaic cell, a wind turbine, and/or a hydropower turbine. Note that such power can be via mains electricity, such as via a power cable.

Note that the computer 1000 can also include and/or be operably coupled to at least one input device, such as a computer keyboard, a computer mouse, a touchpad, a clicker, a scanner, a fax, a biometric reader, a pointer, or other suitable input devices. Likewise, the computer 1000 can include and/or be operably coupled to at least one output device, such as a printer, a projector, or other suitable output devices. Further, at least one of the computer 904, the workstation computer 908, the tablet 910, the desktop computer 912, the laptop computer 914, and the mobile phones 916 can be built according to the computer 1000 schematic.

1. A method for customizing and maximizing a customer referral program based on a social network utilizing a computer with a processor, a memory, and a communications network, comprising:
soliciting a customer, via the computer and communications network, to endorse a product or a service via the customer's social network in exchange for an incentive;
wherein the customer's social network includes a plurality of users;
monitoring the customer's social network via the computer processor;
determining if any of the users took an action in response to the endorsement, gathering data from the users and storing the gathered data in the memory;
analyzing, via the computer processor, the gathered data;
quantifying and predicting the customer's impact on the users in the social network environment;
altering or maintaining the incentive to the customer based on the qualifying and predicting offering a second incentive to the users based on the predicting;
monitoring the customer's and user's social networks to determine if the incentive has an impact on the user's;
adjusting the incentives in real-time based on the monitoring.

2. The method of claim 1 where the adjusting is based on a pre determined incentive program.

3. The method of claim 1 where the first incentive and the second incentive are the same.

4. The method of claim 1 wherein the adjusting is dynamic and is based on an influence factor of the customer's plurality of social network contacts.

5. The method of claim 4 wherein the adjusting is based on data provided by an organization using the system.

6. The method of claim 4 wherein the adjusting is based on data provided by an external provider and wherein the data is data about the customer or a customer profile.

7. The method of claim 1 wherein third-party analytics data is used to predict which incentives have the greatest probability of success for a particular customer during a first interaction with the customer.

8. The method of claim 1 wherein the analyzing includes determining a ripple effect for the customer.

9. The method of claim 1 wherein analyzing includes a determination of the optimum incentive or mix of incentives for a particular category.
